(19) United States
(12) Patent Application Publication
(10) Pub. No.: US 2012/0073752 A1
(43) Pub. Date: Mar. 29, 2012

(54) Adapter Ring For Silicon Electrode

(75) Inventor: Terry Parde, O'Fallon, MO (US)

(73) Assignee: MEMC ELECTRONIC MATERIALS, INC., St. Peters, MO (US)

(21) Appl. No.: 13/237,049

(22) Filed: Sep. 20, 2011

Related U.S. Application Data
(60) Provisional application No. 61/386,153, filed on Sep. 24, 2010.

(51) Int. Cl. C23F 1/08; B23P 17/00

(52) U.S. Cl. 156/345.33; 156/345.43; 29/401.1

(57) ABSTRACT

Methods and systems are provided for retrofitting wafer etching systems. The methods and systems use an adapter ring to retrofit wafer etching systems designed for use with multiple piece electrodes such that single piece electrodes can be used in the etching systems. A portion of the adapter ring is disposed in a receptacle formed in a thermal coupled plate in the wafer etching system. Another portion of the adapter ring is positioned in a channel formed in an upper electrode.

### CROSS-REFERENCE TO RELATED APPLICATIONS

This application claims priority to U.S. Provisional Patent Application No. 61/386,153 filed Sep. 24, 2010, the entire disclosure of which is hereby incorporated by reference in its entirety.

### BACKGROUND

The field of the disclosure relates generally to wafer processing devices, and more specifically to an adapter ring for use with a silicon electrode in a wafer etching device.

Wafers used for semiconductors and solar cells are subjected to a number of processing steps before their eventual fabrication into chips or other structures. One of these steps is referred to as etching and involves the use of a wafer etching device to etch a pattern on the surface of the wafer. The etcher uses electrodes and a flow of process gasses to form plasma which then etches the wafer.

Older etching systems used multi-piece upper electrodes (e.g., a main electrode made of single-crystal silicon surrounded by a ring electrode), however, newer systems may use single piece upper electrodes. Conversion of these older etching systems so that the systems can use single-piece electrodes necessitates removal and replacement of multiple components within the system (e.g., a thermal coupled plate or other support structures). Accordingly, the modification or conversion of previous etching systems to accept single-piece electrodes is a time consuming and costly process.

This section is intended to introduce the reader to various aspects of art that may be related to various aspects of the disclosure, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

### BRIEF SUMMARY

A first aspect is a method for retrofitting a wafer etching system. The method comprises positioning an adapter ring in a receptacle formed in a component of the wafer etching system. At least a portion of a first section of the adapter ring is positioned in the receptacle and at least a portion of a second section of the adapter ring protrudes from the receptacle. An upper electrode having a channel formed therein is then positioned in the system. The upper electrode is positioned in the system such that at least a portion of the second section of the adapter ring is positioned within the channel.

Another aspect is a wafer etching system comprising an etching chamber, an upper electrode, and an adapter ring. The etching chamber has at least one receptacle formed therein. The upper electrode is positioned within the etching chamber and has a front surface, a back surface, and a channel formed in the back surface. The adapter ring has at least a first section and a second section. At least a portion of the first section is configured for placement within the at least one receptacle in the wafer etching device. At least a portion of the second section is configured for placement within the channel formed in the back surface of the upper electrode.

Yet another aspect is a system of components for use in a wafer etching device. The system comprises an adapter ring and an electrode. At least a portion of the adapter ring is configured for placement within a receptacle in the wafer etching device. The electrode has a front surface, a back surface, and a channel formed in the back surface. The channel is configured to receive at least a portion of the second of the adapter ring therein.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1 is a schematic cross-section of a system for etching a wafer;

FIG. 2 is a top plan view of an adapter ring for use in the etching system of FIG. 1;

FIG. 3 is a cross-sectional view of the adapter ring of FIG. 2 taken along the 3-3 line;

FIG. 4 is a top plan view of an upper electrode for use in the etching system of FIG. 1;

FIG. 5 is a cross-sectional view of the upper electrode of FIG. 4 taken along the 5-5 line;

FIG. 6 is a bottom plan view of a thermal coupled plate for use in the etching system of FIG. 1;

FIG. 7 is a cross-sectional view of the thermal coupled plate of FIG. 6 taken along the 7-7 line; and

FIG. 8 is a flow diagram depicting a method for retrofitting a system for etching a wafer.

Corresponding reference characters indicate corresponding parts throughout the drawing.

### DETAILED DESCRIPTION

The embodiments described herein are generally directed to an adapter ring for use with a silicon electrode in wafer processing (e.g., etching) systems and methods of installing the adapter ring in wafer processing systems. For example, the embodiments of adapter rings described herein may be used in systems for etching semiconductor wafers. Other embodiments of adapter rings, while not explicitly described herein, may be used in other systems that use electrodes in processes to process other substrates or materials. Moreover, some embodiments may be used in systems that use electrodes in other processes performed on materials.

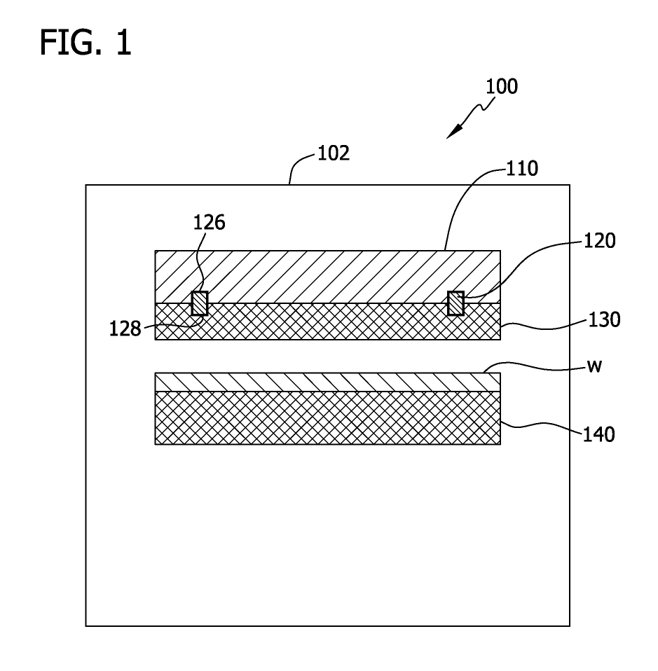

FIG. 1 is a partial cross-sectional schematic of an exemplary system 100 for etching a wafer. The system 100 is used to etch semiconductor wafers in the embodiment of FIG. 1. In other embodiments, the system 100 may be used to etch other substrates or structures. Various components of the system 100 are omitted from FIG. 1 for the sake of clarity.

The system 100 includes a housing 102 in which the other components of the system are positioned. The housing 102 is sufficiently sealed from the surrounding environment such that a low-pressure atmosphere (i.e., pressures less than 500 millitorr) can be maintained within the housing 102.

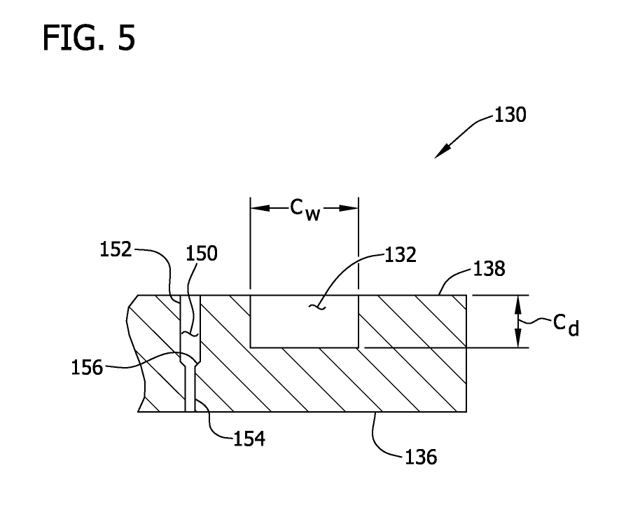

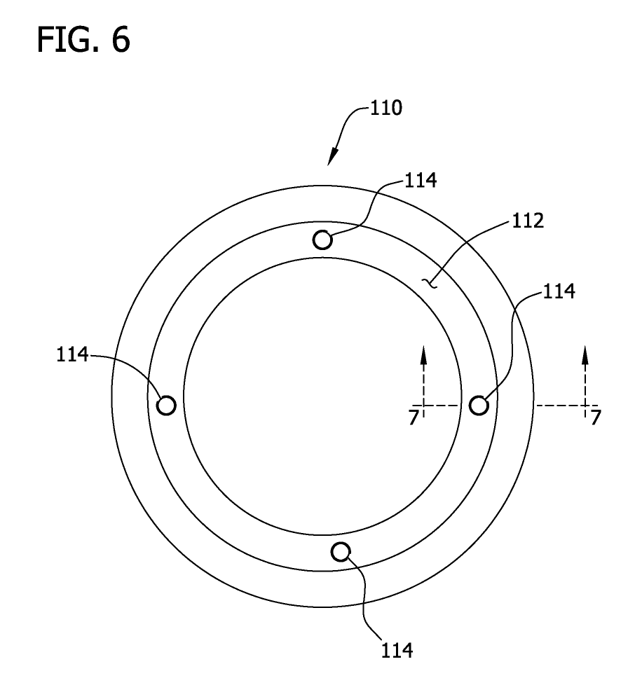

A thermal coupled plate 110, an adapter ring 120, an upper electrode 130, and a lower electrode 140 are positioned within the housing 102 of the system. A wafer W is positioned atop the lower electrode 140 and may be held in place by an electrostatic chuck (not shown). These components of the system 100 (with the exception of the housing 102) are generally circular in overall shape in the embodiments described herein because the wafers processed in the system are similarly shaped. In other embodiments, the components of the system 100 may be differently shaped in order to process differently shaped wafers. In operation, the system 100 generally functions by introducing a flow of gas through openings 150 (FIGS. 5 and 6) in the upper electrode 130 and striking or initiating a plasma. The plasma then etches the surface of the wafer W.

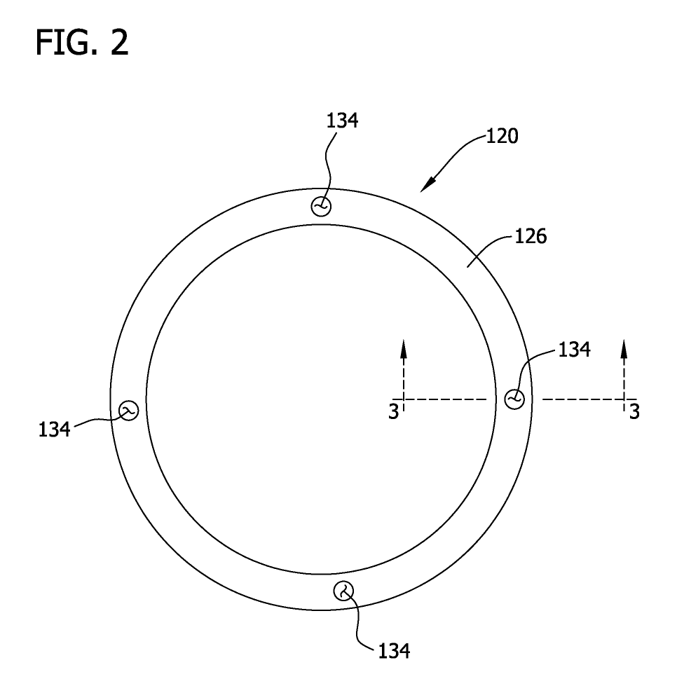

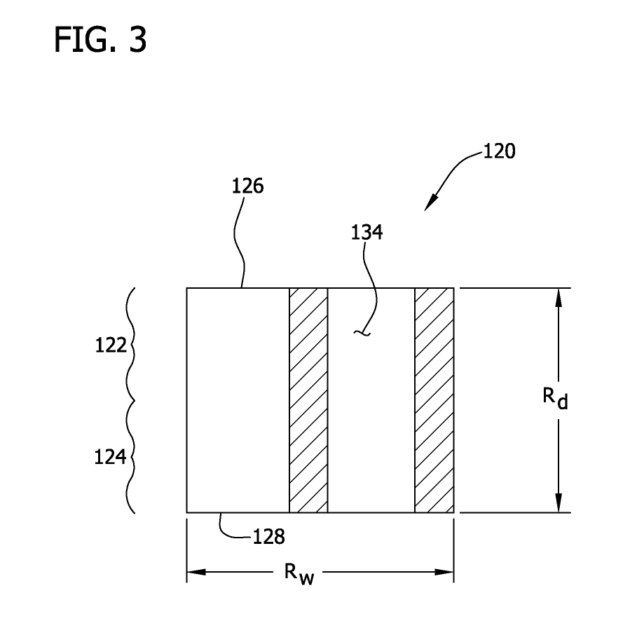

The adapter ring 120 of FIGS. 2 and 3 has a depth R_{d} and a width R_{w}. The adapter ring 120 is generally circular in overall shape as shown in FIG. 2 and is formed from any suitable metal or material that has sufficient rigidity and mechanical strength. Example materials include aluminum, steel and alloys thereof, titanium, ceramics, or composite materials. As shown in FIG. 3, the adapter ring 120 is square in cross-sectional shape, although in other embodiments it may be rectangular or oblong. Moreover, while the adapter ring 120 is shown in the Figures as being continuous, in other embodiments the adapter ring 120 may be formed from multiple, separate pieces such that the adapter ring 120 may or may not have breaks or other discontinuities when in use in the system 100.

The adapter ring 120 also has a first section 122 and a second section 124. The first section 122 is generally the upper half of the adapter ring 120 while the second section 124 is generally the lower half thereof. A front surface 126 of the adapter ring 120 is generally adjacent the first section 122. A back surface 128 of the adapter ring 120 is generally adjacent the second section 124 thereof. While the adapter ring 120 has a uniform cross-sectional shape in the embodiment of FIG. 3, in other embodiments the cross-sectional shape may not be uniform. The width or shape of the first section 122 of the adapter ring 120 may thus differ from the width or shape of the second section 124. For example, the cross-sectional shape of the first section 122 may be tapered such its width near front surface 126 is greater than the width of the section nearest the second section 124 and the back surface 128. In this example, the second section 124 may have a square cross-sectional shape or it may be tapered or have any other suitable shape.

Multiple bore openings 134 are formed in the adapter ring 120 that are generally perpendicular to the front surface 126 and/or the back surface 128. In some embodiments, the bore openings 134 may be formed in the adapter ring 120 at an angle (e.g., less than about 10 degrees from perpendicular) relative to the front surface 126 and the back surface 128. In such embodiments, openings 114 formed in the thermal coupled plate 110 (described in greater detail below) may likewise be angled.

The multiple bore openings 134 formed in the adapter ring 120 are sized such that fastening devices (not shown) can be inserted therethrough to fasten or secure the adapter ring 120 to the thermal coupled plate 110. In other embodiments, the adapter ring 120 may be adhesively or chemically bonded in the receptacle 112 in the thermal coupled plate 110, and the bore openings 134, openings 114, and associated fasteners may or may not be used.

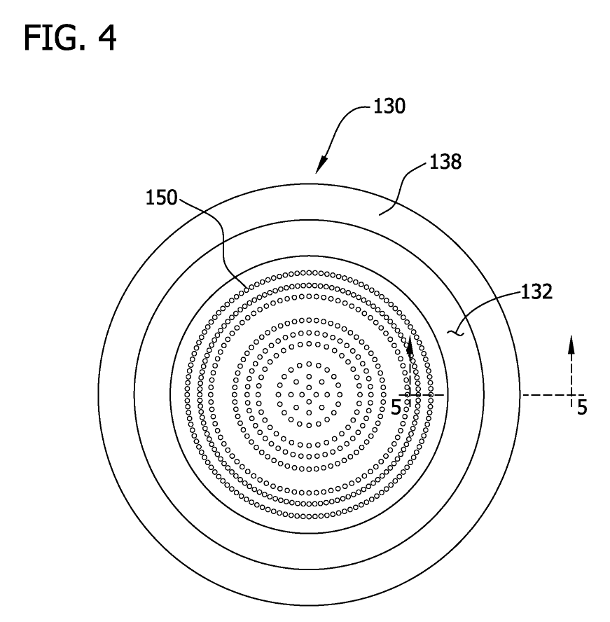

The upper electrode 130, as best seen in FIGS. 4 and 5, is positioned beneath the thermal coupled plate 110 and is generally circular in shape. In the embodiment of FIGS. 1-7, the upper electrode 130 is formed from silicon, although in other embodiments it may be formed from other materials. The upper electrode 130 is fastened or secured to the thermal coupled plate 110 and/or the adapter ring 120 with any suitable fastening device (not shown). The upper electrode has a front surface 136 and a back surface 138. A channel 132 is formed in the back surface 138 of the upper electrode 130 about the entire circumference of the upper electrode. The channel 132 has a depth C_{d} and a width C_{w}. While the upper electrode 130 is shown in FIGS. 4 and 5 as having substantially planar back surface 138 (with the exception of channel 132) a significant portion of the upper electrode 130 adjacent the back surface 138 may be removed therefrom so that the electrode 130 is thinner. In this embodiment, the upper electrode 130 has a “dished” shape such that it has a greater thickness along its periphery than a central portion thereof.

A plurality of gas distribution openings 150 are also formed in the upper electrode 130. The gas distribution openings 150 permit gas to flow through the upper electrode 130 from the back surface 138 to the front surface 136 thereof. The arrangement of the gas distribution openings 150 shown in FIG. 4 is exemplary in nature. Other embodiments may use different numbers and/or arrangement of gas distribution openings 150 without departing from the scope of the disclosure.

An exemplary gas distribution opening 150 is shown in the cross-sectional view of FIG. 5 and its size is greatly exaggerated for the sake of clarity. Each of the gas distribution openings 150 has an upper portion 152 and a lower portion 154. The upper and lower portions 152, 154 are co-axial in the example embodiment. The upper portion 152 extends from the back surface 138 of the upper electrode 130 while the lower portion 154 extends from the front surface 136. The upper portion 152 transitions to the lower portion 154 at a tapered portion 156 in the exemplary embodiment. In other embodiments, the tapered portion 156 may be omitted. The depth of the portions 152, 154 are approximately equal in the exemplary embodiment, while in other embodiments the depths may be different. In the exemplary embodiment, the diameter of the upper portion 152 (i.e., a first diameter) is between approximately (e.g., plus or minus 0.2 mm) 0.8 mm and 2.5 mm and the diameter of the lower portion 154 (i.e., a second diameter) is approximately 0.5 mm.

In the exemplary embodiment, gas distribution openings 150 may be formed by drilling or boring a hole in the back surface 138 of the upper electrode 130 to form the upper portion 152 and drilling or boring another hole in the front surface 136 to form the lower portion 154. In other embodiments, gas distribution openings 150 may be formed according to any suitable manufacturing method.

The dual diameter arrangement of the gas distribution openings 150 results in improved gas conductance through the openings 150. The dual diameter arrangement also significantly reduces the costs and complexity of forming (e.g., drilling or boring) the gas distribution openings 150 in the upper electrode 130. In the exemplary embodiment, the upper electrode 130 may have a thickness such that it is difficult to drill or bore an opening therethrough. The arrangement of the gas distribution openings 150 thus results in the depth of the portions 152, 154 thereof being approximately half the thickness of the upper electrode 130. Accordingly, the cost and difficulty in forming such a relatively small-diameter opening (e.g., the lower portion 154) is significantly reduced by using the arrangement of the portions 152, 154.

In other embodiments, gas distribution openings may have a tapered diameter. This opening would have a diameter that is largest at the back surface 138, and then tapers to a smaller diameter at the front surface 136 of the upper electrode 130.

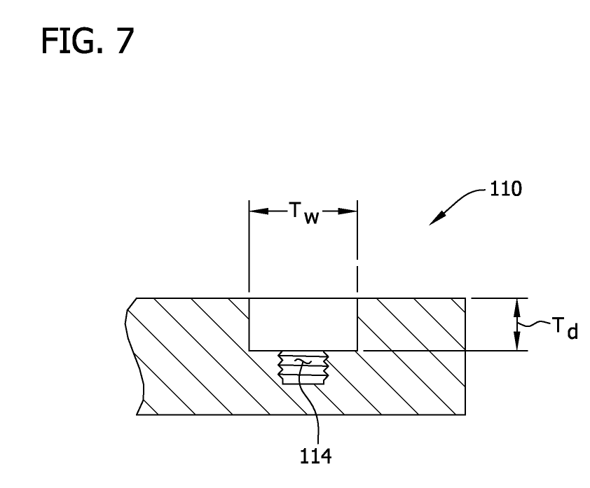

The thermal coupled plate 110 of FIGS. 6 and 7, is generally circular in shape and has a receptacle 112 formed therein that is generally circular shaped as well and has a rectangular or square cross-sectional shape. In the embodiments of FIGS. 6 and 7, the receptacle 112 is a continuous annular groove that has a width T_{w} and a depth T_{d}. The thermal coupled plate 110 may also have additional receptacles formed in it without departing from the scope of the embodiments.

Multiple openings 114 are formed in the receptacle 112 that are sized to receive mechanical fastening devices. The position and number of the openings 114 correspond with the position and number of the bore openings 134 formed in the adapter ring 120. Accordingly, mechanical fastening devices can pass through the bore openings 134 and into the openings 114 in the thermal coupled plate 110. The openings 114 may be threaded to receive threaded fasteners in some embodiments. The thermal coupled plate 110 of FIGS. 6 and 7 has four such openings 114, although other embodiments may use any number of openings.

While the openings 114 shown in FIG. 7 do no penetrate completely through the thermal coupled plate 110, in other embodiments the openings may do so. In these embodiments, the fastening devices can pass completely through the openings 114 and are secured with other components (e.g., nuts) disposed adjacent the thermal coupled plate 110.

The widths C_{w} of the channel 132 and T_{w} of the receptacle 112 are suitably sized such that the adapter ring 120 can be placed therein. In the embodiments of FIGS. 1-7, the widths C_{w} and T_{w} may be about 0.5 millimeters greater than the width R_{w} of the adapter ring 120. In other embodiments, the widths C_{w} and T_{w} may be between about 0.5 and about 1.0 millimeters greater than the width R_{w} of the adapter ring 120.

The depths C_{d} of the channel 132 and T_{d} of the receptacle 112 are also suitably sized such that their sum is equal to or approximately equal to the depth R_{d} of the adapter ring 120. In other embodiments, the depth R_{d} may be less than or greater than the sum of the depths C_{d} and T_{d}. In the embodiments of FIGS. 1-7, the depth T_{d} of the receptacle 112 is equal to or approximately equal to the depth of the first section 122 of the adapter ring 120. The depth C_{d} of the channel 132 is also equal to or approximately equal to the depth of the second section 124.

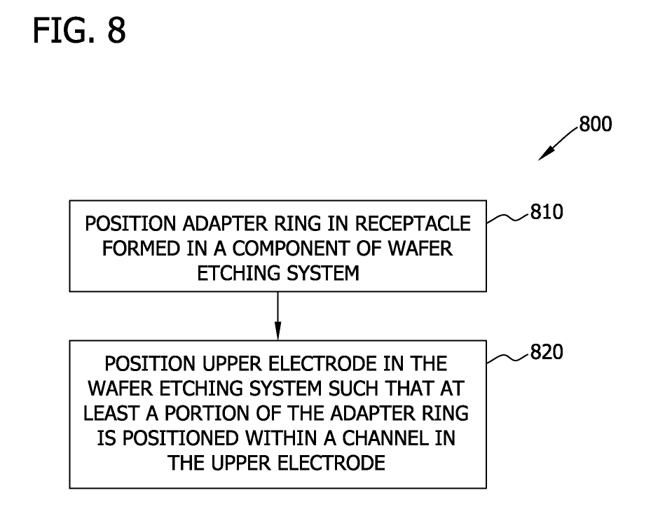

FIG. 8 is a flow diagram depicting a method 800 of retrofitting a system for etching a wafer. The method 800 can be used to retrofit a wafer etching system designed for use with multiple piece (e.g., two-piece) upper electrodes such that the system can use single piece electrodes. The adapter ring 120 described above can be used in the method 800 to retrofit the wafer etching system.

The method 800 begins in block 810 with the positioning of an adapter ring in a receptacle formed in a component (e.g., a thermal coupled plate) of the wafer etching system. At least a portion of a first section of the adapter ring is positioned in the receptacle formed in the component and at least a portion of a second section of the adapter ring protrudes from the receptacle. The adapter ring may then be secured to the component of the wafer etching system with any suitable fastening devices.

In block 820, an upper electrode is positioned in the wafer etching system. The upper electrode has a channel formed therein and is positioned in the system such that at least a portion of the second section of the adapter ring is positioned within the channel. The upper electrode may then be secured within the system and/or to the component with any suitable fastening devices. The system may then be used to etch wafers, substrates, or other structures.

The systems and methods described herein thus permit the retrofitting of multiple piece electrode wafer processing systems such that these systems are able to use single piece upper electrodes. Previously, retrofitting a multiple piece electrode wafer processing system required the disassembly and replacement of multiple costly components in the system. In the systems described herein, however, wafer processing systems are able to be retrofitted with an adapter ring positioned within the system between a portion of a single piece electrode and another component of the system. Accordingly, the adapter ring described herein permits single piece electrodes to be used in the wafer processing systems without the need to disassemble and replace multiple components in these systems.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description and shown in the accompanying drawing[s] shall be interpreted as illustrative and not in a limiting sense.

What is claimed is:

1. A method for retrofitting a wafer etching system comprising:
positioning an adapter ring in a receptacle formed in a component of the wafer etching system, wherein at least a portion of a first section of the adapter ring is positioned in the receptacle and wherein at least a portion of a second section of the adapter ring protrudes from the receptacle; and
positioning an upper electrode in the system, the upper electrode having a channel formed therein, wherein the upper electrode is positioned in the system such that at least a portion of the second section of the adapter ring is positioned within the channel.

2. The method of claim 1 further comprising securing the adapter ring in the receptacle with one or more fastening devices.

3. The method of claim 1 further comprising securing the upper electrode in the system with one or more fastening devices.

4. A wafer etching system comprising:
an etching chamber having at least one receptacle disposed therein;
an upper electrode positioned within the etching chamber, the upper electrode having a front surface, a back surface, and a channel formed in the back surface; and
an adapter ring having at least a first section and a second section, at least a portion of the first section being configured for placement within the at least one receptacle in the wafer etching device, at least a portion of second section being configured for placement within the channel formed in the back surface of the upper electrode.

5. The system of claim 4 further comprising a thermal coupled plate disposed in the etching chamber, the at least one receptacle formed in the thermal coupled plate.

6. The system of claim 4 wherein the adapter ring has a front surface adjacent at least a portion of the first section and a back surface adjacent at least a portion of the second section.

7. The system of claim 6 further comprising one or more openings formed in the adapter ring, wherein the one or more openings are generally perpendicular to at least one of the front surface and the back surface of the adapter ring.

8. The system of claim 4 wherein the adapter ring has a rectangular cross-sectional shape.

9. A system of components for use in a wafer etching device, the system comprising:
an adapter ring, at least a portion of the adapter ring being configured for placement within a receptacle in the wafer etching device; and
an electrode having a front surface, a back surface, and a channel formed in the back surface, the channel being configured to receive at least a portion of the second section of the adapter ring therein.

10. The system of claim 9 wherein the adapter ring and the channel formed in the back surface of the electrode are circular in overall shape.

11. The system of claim 10 wherein the adapter ring has a width and wherein the channel formed in the back surface of the electrode has a width that is at least 0.5 millimeters greater than the width of the adapter ring.

12. The system of claim 9 wherein the adapter ring has a first section and a second section and wherein at least a portion of the first section is configured for placement with the receptacle in the wafer etching device.

13. The system of claim 12 wherein the adapter ring has a front surface adjacent at least a portion of the first section and a back surface adjacent at least a portion of the second section.

14. The system of claim 13 further comprising one or more openings formed in the adapter ring, wherein the one or more openings are generally perpendicular to the front surface and the back surface of the adapter ring.

15. The system of claim 9 wherein the adapter ring has a rectangular cross-sectional shape.

16. The system of claim 15 wherein the adapter ring has a square cross-sectional shape.

17. The system of claim 9 wherein the receptacle in the wafer etching device is an annular groove.

18. The system of claim 9 wherein the receptacle in the wafer etching device has a rectangular cross-sectional shape.

19. The system of claim 18 wherein the receptacle in the wafer etching device has a square cross-sectional shape.

20. The system of claim 9 further comprising a plurality of gas distribution openings formed in the electrode, each of the openings having a larger diameter adjacent the back surface of the electrode and a smaller diameter adjacent the front surface of the electrode.

21. The system of claim 20 wherein each of the openings has an upper portion with a first diameter generally adjacent the back surface of the electrode and a lower portion with a second diameter generally adjacent the front surface of the electrode.

22. The system of claim 20 wherein the first diameter of the upper portion of the gas distribution openings is greater than the second diameter of lower portion of the gas distribution openings.
